(19) United States
(12) Patent Application Publication
(10) Pub. No.: US 2010/0181737 A1
(43) Pub. Date: Jul. 22, 2010

(54) Transportation cart for power tools

(75) Inventors: Tamara Reinicke, Kaufering (DE); Josef Hasler, Hinterforst (CH)

Correspondence Address: Davidson, Davidson & Kappel, LLC, 485 7th Avenue, 14th Floor, New York, NY, 10018, US

(73) Assignee: Hilti Aktiengesellschaft, Schaan (LI)

(21) Appl. No.: 12/657,465

(22) Filed: Jan. 21, 2010

(30) Foreign Application Priority Data
Jan. 22, 2009 (DE) DE 102009000368.1

(51) Int. Cl. B62B 1/14; B62B 1/26

(52) U.S. Cl. 280/47.19

(57) ABSTRACT

A transportation cart for power tools includes at least two wheels arranged coaxially to each other, a load-bearing structure, a guide structure that has at least one handle and that is joined to the load-bearing structure, as well as several cylindrical receptacles as a holding device for tools. A holding element including a spring element is arranged in each cylindrical receptacle.

This claims the benefit of German Patent Application No. 10 2009 000 368.1, filed on Jan. 22, 2009 and hereby incorporated by reference herein

The invention relates to a transportation cart for power tools.

### BACKGROUND

Such transportation carts serve to transport a power tool and the tools that can be used with it such as, for example, chiseling tools.

The Hitachi company, for instance, markets transportation carts for power tools such as chiseling hammers or demolition hammers, said carts having two wheels arranged coaxially to each other, having a ledge with a receptacle for the tool-receiving socket of the power tool as the load-bearing structure and having a grip frame as a handle that is joined to the load-bearing structure via a guide structure. In order to transport and hold power tools such as a pointed chisel or a spade chisel, several cylindrical receptacles are provided as a holding device. A tool is inserted from the top into the receptacle, whereby the collar of the tool or the axle of the wheels form a stop for the tool when it is inserted.

A drawback of the prior-art transportation carts is that the tools inserted into the receptacles can easily be ejected from the receptacles when the transportation cart moves over uneven or rough ground, which is very inconvenient for the user of such a transportation cart. Moreover, the inserted tools can fall out when the transportation cart is in an essentially vertical position, for example, when the transportation cart is being transported on the cargo bed of a vehicle.

### SUMMARY OF THE INVENTION

It is an object of the present invention to provide a transportation cart with a holding device for tools that avoids the above-mentioned drawbacks and that allows safe transportation and safe storage of tools having shafts of different diameters.

The present invention provides a transportation cart for power tools, comprising at least two wheels arranged coaxially to each other, a load-bearing structure, a guide structure that has at least one handle and that is joined to the load-bearing structure, as well as at least one cylindrical receptacle as a holding device for tools.

According to the invention, at least one holding element comprising a spring element is arranged in the at least one cylindrical receptacle.

In this context, the term cylindrical refers to the shape of the at least one receptacle which is essentially circumferentially closed and which has a lengthwise extension in the insertion direction that is greater than an extension of the at least one receptacle running perpendicular thereto. In this context, the at least one receptacle does not necessarily have to have a circular-cylindrical configuration.

The spring element of the at least one holding element can taper the appertaining receptacle and advantageously extends over a large portion of the lengthwise extension of this receptacle. Thanks to the spring element, the at least one holding element exhibits advantageous elastic properties and a low level of wear and tear. When a tool, for example, the insertion end of a chisel, is inserted, the spring element of the at least one holding element is pushed aside, as a result of which the inserted tool is clamped between the spring element of the holding element and the inner wall of the at least one receptacle, and said tool is securely held in the at least one receptacle by the frictional contact thus generated. In this context, the tool is held non-rotatably in the at least one receptacle, which is particularly advantageous when the tool held in the at least one receptacle is a spade chisel. During its transportation, a tool held in this way cannot twist in such a manner that any tips or projections of the tool that might be present could protrude, for instance, at knee height beyond the confines created by the transportation cart. Moreover, owing to the fact that the tool is held by frictional contact in the at least one receptacle, the tool can no longer rattle during transportation, thus reducing the noise level. Besides, tools of different sizes can be held in the at least one receptacle, since the at least one holding element, which is elastic because of the spring element, adapts to the dimensions of the section of the tool that has been inserted.

Advantageously, a holding element is provided in each receptacle of the transportation cart. As an alternative, several holding elements are provided in each receptacle, whereby at least two of these holding elements overlap, at least in certain places, relative to the lengthwise extension of the appertaining receptacle.

Preferably, the spring element is made up of a section of a steel strip, as a result of which it is easy to manufacture. Particularly a spring element made of a steel strip that is preferably a spring steel exhibits advantageous elastic properties and a low level of wear and tear.

At least one of the ends of the at least one holding element preferably has a bent section to grip around areas of an edge of the at least one cylindrical receptacle, as a result of which the holding element can be easily affixed onto or into the at least one receptacle.

Preferably, a notch is provided on at least one of the edges of the at least one cylindrical receptacle to receive a section of the at least one holding element, as a result of which the at least one holding element in its fixed state is secured against shifting sideways in the at least one receptacle. If the at least one holding element has a bent section on at least one of its ends, then part of this bent section is advantageously accommodated in the notch or else this bent section grips around at least areas of an edge of the notch.

Preferably, the at least one holding element has a bent section on both ends that are opposite from each other so as to grip around areas of the two opposite edges of the at least one cylindrical receptacle. The at least one holding element extends essentially over the entire lengthwise extension of the appertaining receptacle and correspondingly narrows the receiving space formed by this receptacle.

Notches are advantageously provided on the two opposite edges of the at least one receptacle, whereby one end of the holding element grips around the edges of said notches when said holding element is in its mounted state.

In its relaxed state, the opposite ends of the at least one holding element are preferably at a distance from each other that is smaller than a corresponding lengthwise extension of the at least one cylindrical receptacle. As a result, the at least one holding element in its mounted state is held securely in the appertaining receptacle.

Furthermore, this configuration of the at least one holding element allows simple mounting in the appertaining receptacle. For example, one end of the holding element is placed around an edge of the appertaining receptacle and subsequently a tool such as, for instance, an appropriately configured auxiliary tool, is inserted into this receptacle. Due to the lengthening of the at least one holding element brought about by the insertion of the tool, the opposite end of the at least one holding element moves into a position so as to grip around the opposite edge of the receptacle and snaps over this edge. In this manner, a user can easily mount a holding element and, if necessary, replace it.

### BRIEF DESCRIPTION OF THE DRAWINGS

The invention will be explained in greater detail below on the basis of an embodiment. The following is shown:

FIG. 1—a perspective view of a transportation cart;

FIG. 2—an outline of part of the receptacles;

FIG. 3—a section through a receptacle along line III-III in FIG. 2; and

FIG. 4—a side view of a holding element.

### DETAILED DESCRIPTION

Fundamentally speaking, identical parts are designated with the same reference numerals in the figures.

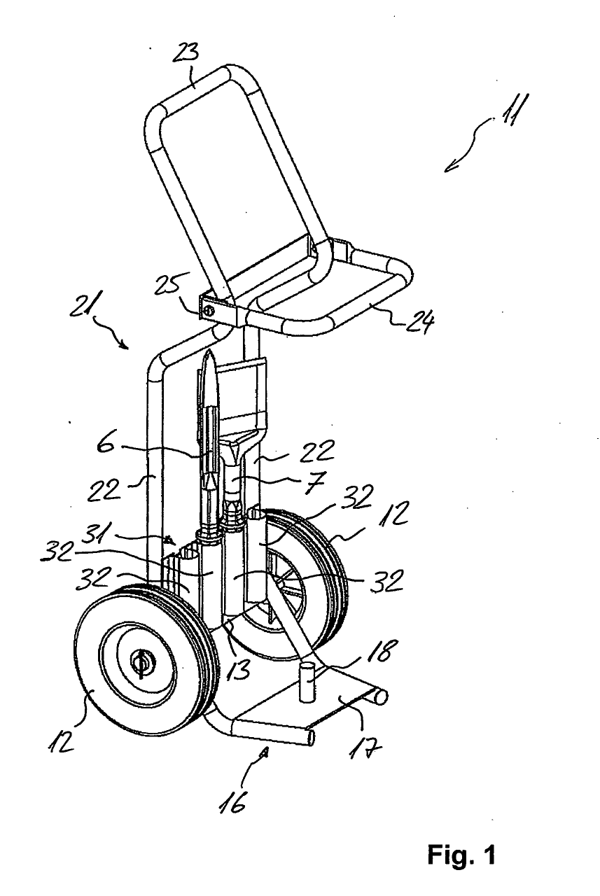

The transportation cart 11 depicted in FIG. 1 for a heavy power tool such as a chiseling hammer or a demolition hammer, has two wheels 12 arranged coaxially to each other and joined to each other by means of an axle 13. Moreover, the transportation cart 11 has a ledge 17 with a centering pin 18 as the load-bearing structure 16. A power tool placed onto the transportation cart 11 is held by means of the centering pin 18 on the transportation cart 11 in the area of the tool-receiving socket of said power tool. The ledge 17 is secured at the free end areas of two tie bars 22 that form a guide structure 21 and that are joined to each other at the opposite end by means of a gripping section in the form of a handle 23 of the transportation cart 11. Moreover, the guide structure 21 comprises a swivel bar 24 that can be swiveled around a swivel bearing 25 and that holds a power tool placed onto the transportation cart 11 in an area that is at a distance from the tool-receiving socket of the power tool on the transportation cart 11.

A holding device 31 for tools such as a pointed chisel 6 or a spade chisel 7 is provided between the two tie bars 22 above the axle 13 of the wheels 12, said holding device 31 having four cylindrical receptacles 32.

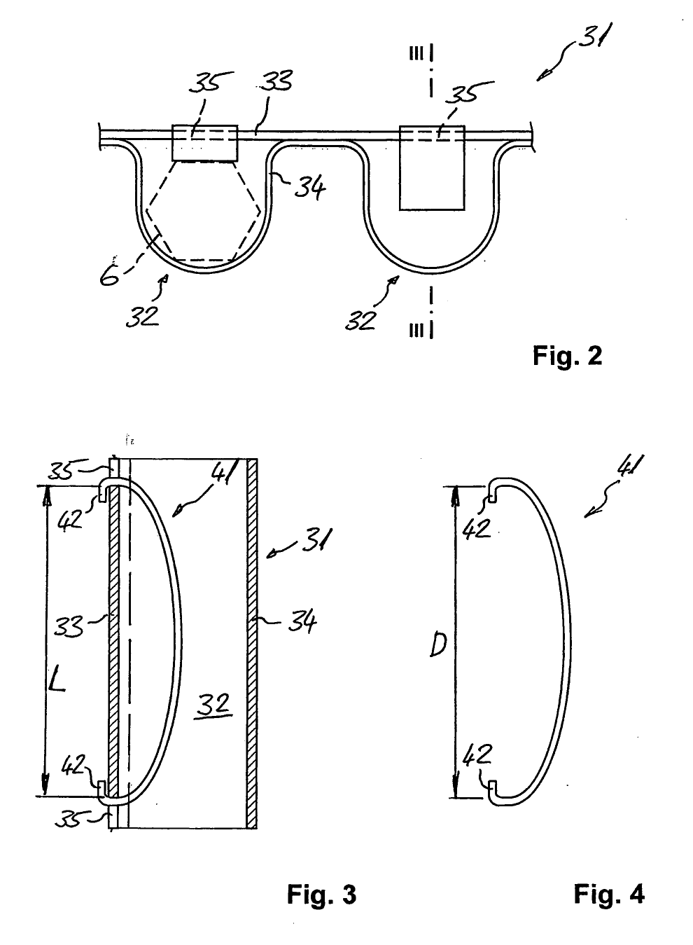

The cylindrical receptacles 32, as shown in detail in FIGS. 2 and 3, are formed by a first, essentially flat sheet metal part 33 and a second, undulated sheet metal part 34, which are joined to each other at their points of contact by means of, for example, welding or soldering points. On both of its edges that are opposite from each other, the first sheet metal part 33 has notches 35 that are arranged at a distance from each other in areas near the cylindrical receptacles 32. In the area of the notches 35 that are opposite from each other, the cylindrical receptacles 32 have a shorter lengthwise extension L than elsewhere in the cylindrical receptacle 32.

A spring element is arranged in each of the cylindrical receptacles 32 as a holding element for a tool 6 or 7 that is inserted into the cylindrical receptacle 32. The spring element, which consists of a section of a steel strip, extends essentially over the entire lengthwise extension of the cylindrical receptacle 32. Both ends of the holding element 41 that are opposite from each other have a bent section 42 that grips around areas of the opposite edges of the notches 35 that are opposite from each other, and thus of the cylindrical receptacle 32.

In its relaxed state, the opposite ends of the holding element 41 (FIG. 4), or the rounded parts of the bent sections 42, are at a distance D from each other that is smaller than an appertaining lengthwise extension L of the cylindrical receptacle 32.

What is claimed is:

1. A transportation cart for power tools, comprising:
at least two wheels arranged coaxially to each other;
a load-bearing structure;
a guide structure having at least one handle and joined to the load-bearing structure;
at least one cylindrical receptacle as a holding device for tools; and
at least one holding element including a spring element arranged in the at least one cylindrical receptacle.

2. The transportation cart as recited in claim 1 wherein the spring element is made up of a section of a steel strip.

3. The transportation cart as recited in claim 1 wherein at least one of the ends of the at least one holding element has a bent section gripping around areas of an edge of the at least one cylindrical receptacle.

4. The transportation cart as recited in claim 1 wherein a notch is provided on at least one of the edges of the at least one cylindrical receptacle to receive a section of the at least one holding element.

5. The transportation cart as recited in claim 3 wherein the at least one holding element has a bent section on both ends that are opposite from each other so as to grip around areas of the two opposite edges of the at least one cylindrical receptacle.

6. The transportation cart as recited in claim 5 wherein, in its relaxed state, the opposite ends of the at least one holding element are at a distance from each other that is smaller than a corresponding lengthwise extension of the at least one cylindrical receptacle.

7. The transportation cart as recited in claim 4 wherein the at least one holding element has a bent section on both ends that are opposite from each other so as to grip around areas of the two opposite edges of the at least one cylindrical receptacle.

8. The transportation cart as recited in claim 7 wherein, in its relaxed state, the opposite ends of the at least one holding element are at a distance from each other that is smaller than a corresponding lengthwise extension of the at least one cylindrical receptacle.
